(19) United States
(12) Patent Application Publication
(10) Pub. No.: US 2003/0190922 A1
(43) Pub. Date: Oct. 9, 2003

(54) Method and system for detecting repetitive bit patterns

(76) Inventors: Aneesh Dalvi, Greely (CA); Clive Anthony Anderson, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 09/814,866

(22) Filed: Mar. 23, 2001

(30) Foreign Application Priority Data
Mar. 23, 2000 (CA) 2,302,958

(51) Int. Cl. H04B 7/005

(52) U.S. Cl. 455/502; 455/517; 455/526; 455/12.1

(57) ABSTRACT

A system and method that detects a repetitive word, called a Sync Word, from a continuous bit stream is disclosed. In an acquisition mode, counters are used for detecting a Sync Word, which can be up to 64 bits in length. When the Sync Word has been detected for a fixed consecutive number of times, the system switches to a tracking mode in which data from the bit stream is output. The Sync Word can be one of two types of markers, and in combination can appear as a specific pattern. The Sync Word and pattern of Sync Words to be detected in the bit stream, are programmable.

### FIELD OF THE INVENTION

The present invention relates to digital telecommunications. In particular, the present invention relates to a method and system for detecting a repetitive bit pattern from a continuous bit stream.

### BACKGROUND OF THE INVENTION

In communication systems a transmitter sends data to a receiver, over a channel as a series of symbols. In practice the symbol set used in modem telecommunications is the binary digit set, composed of the bits ‘1’ and ‘0’. The transmitted symbols can be converted into characters, or other useable formats, by the receiver so long as the receiver starts decoding at the correct point in the communication data stream. This is an issue in many communication systems, but is especially prevalent in wireless broadcasts, where the receiver can come online at any point in the transmission.

As a simple example of why this is an issue examine the transmission of a series of bits representing an unencoded ASCII transmission. If a receiver is expecting simple non-parity 8-bit ASCII transmissions and it receives the following bits as the first bits that it receives “001000010” it could interpret the received string in a number of ways. The receiver could look at the first eight bits and decode the string as ‘!’, or it could assume that the first bit was the end of another character and then decode the next 8 bits as ‘B’. Additionally the receiver could assume that the character starts at any arbitrary point and continually interpret the data stream incorrectly. A far worse situation can occur if the data being transmitted in the data stream is of a higher complexity and a more rigorously designed format than simple ASCII.

To resolve this, many transmission system utilize a synchronizing word, which is inserted into the data stream at regular intervals to allow a receiver to know where to start the decoding process. This segments the data stream into sync word and data word segments. The data word segments may contain application level data as well as other information such as header, but regardless of the content the symbols not in the sync word segment are considered to be a part of the data word segment. Thus a receiver must search for this sync word, and start decoding the symbols in the data word segment only after finding the sync word. Though this is simple in principle, difficulties arise as a result of sync words appearing in the data word segment due to the random nature of the symbols in the data word segment. To overcome the instances of unintentional sync words the receiver must check for a repeating sync word before each data word segment. If the sync word does not repeat in the expected spot it is a result of either error in detecting the sync word in the original sync word, or a problem with the second sync word.

The position of the sync word, and the actual word itself are defined in a standard used by both the transmitter and the receiver. Different standards call for different placement of the sync words and different sync words as well. Additionally some standards call for a very structured approach with more than one sync word that is used to denote more than word format. For example a particular sync word may indicate the start of a frame, while another may indicate the start of a super frame that consists of many frames. Traditionally receivers have been able to select a few standards for decoding, but if a new standard is presented the receiver is unable to adapt to it. Many conventional receivers also lack the robustness required to operate in noisy environments without prematurely losing the sync lock on a good data steam.

It is therefore desirable to provide a system and method that overcomes the problems of the prior art.

### SUMMARY OF THE INVENTION

It is an object of the present invention to provide a sync detect circuit block which is capable of acquiring a lock onto a repetitive word, called a Sync Word, from a continuous symbol stream. It is a further object of the invention to provide a system and method that obviate or mitigate some of the disadvantages of the prior art.

In an embodiment of the present invention there is provided a method of acquiring word-based synchronization, to a transmitter, in a receiver receiving a datastream of data words separated by synchronization words, comprising the steps of identifying a first synchronization word candidate, determining that no synchronization word is present at the location of a subsequent expected synchronization word, finding a next synchronization word candidate and, asserting synchronization of the receiver to the transmitter if a synchronization word is present at an expected location. In further aspects of the above described embodiment there are a plurality of synchronization words used to separate the data words, these synchronization words may additionally be selectable and changeable. If there are a plurality of distinct synchronization words they can be used indicate different data structures in the datastream, and the comparison of the datastream to each distinct synchronization word can be done either serially or in parallel. In yet another aspect of the previously described embodiment the phase of the received data stream may be rotated after a sufficient number of unsuccessful attempts to find a synchronization word candidate, alternatively a plurality of phases of the received datastream may be analyzed simultaneously, and the phases not synchronized to discarded. In a further aspect of the previously described embodiment of the present invention the location of a subsequent synchronization word determined by moving a multiple of the length of a data word from the end of the previous synchronization word candidate.

In a second embodiment of the present invention there is disclosed a method of tracking loss of word-based synchronization, to a transmitter, in a receiver receiving a datastream of data words separated by synchronization words, comprising the steps of failing to detect a synchronization word at an expected location and asserting the loss of synchronization of the receiver to the transmitter if the step of failing to detect a synchronization word is repeated a predetermined number of times. In aspect of the previously described embodiment there is provided the further step of selecting the synchronization word, or words, searched for in the datastream. Each of the aforementioned words can be compared to the datastream serially or in parallel, and may denote structure in the datastream. In a further aspect of the previously described embodiment of the present invention the location of a subsequent synchronization word determined by moving a multiple of the length of a data word from the end of the previous synchronization word candidate. Additionally there is provided another aspect of the present invention in which asserting the loss of synchronization of the receiver requires failing to detect a synchronization word in consecutive attempts, or failing to detect a synchronization word a predetermined number of non-consecutive times in a predetermined number of attempts.

In a third embodiment of the present invention there is provided a system for acquiring and tracking word-based synchronization, to a transmitter, of a receiver receiving a datastream of data words separated by synchronization words, comprising the following elements, a synchronization word detector, for receiving the datastream and providing a synchronization word detect signal when a synchronization word in the datastream is detected, and a synchronization detector, operatively connected to the synchronization word detector, for receiving the synchronization word detect signal and for providing a synchronization lock signal when a predetermined number of synchronization words are detected. Optionally the synchronization word detector includes a synchronization word table, that may be programmable, and contain at least one synchronization word, but may contain a plurality of words. Additionally there may be a comparator that provides a synchronization word detect signal when any synchronization word in the synchronization word table is detected in the datastream. The previously described embodiment of the present invention may, in one aspect, include phase rotator, or a synchronization word detector detects the presence of a synchronization word in any phase of the datastream and a phase selector to select the phase containing the synchronization words. Optionally the synchronization detector includes a protocol table that may be programmable and may contain information about the structure of more than one datastream protocol.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an overview of a system of the present invention;

FIG. 2 is a flow chart detailing a method of the present invention;

FIG. 3 is a flow chart detailing a method of the present invention;

FIG. 4 is a flow chart detailing a method of the present invention;

FIG. 5 is a flow chart detailing a method of the present invention;

FIG. 6 is a flow chart detailing a method of the present invention;

FIG. 7 is a flow chart detailing a method of the present invention;

FIG. 8 is a block diagram of a system of the present invention;

FIG. 9 is a block diagram of a system of the present invention; and

FIG. 10 is a block diagram of a system of the present invention;

### DETAILED DESCRIPTION OF THE INVENTION

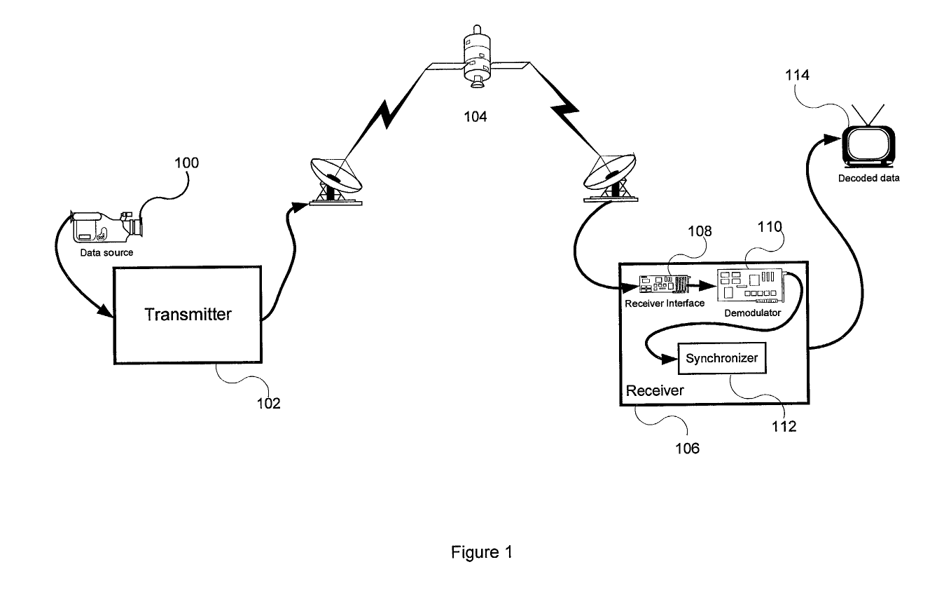

Generally, the present invention provides a method and system for detecting repetitive symbol patterns that denote the flags upon which synchronization of a receiver to a transmitter are based. FIG. 1 illustrates the system in which the invention interacts. A data source 100 provides information to a transmitter 102. If the data is not already in a transmittable format the transmitter 102 processes it. The data is formatted by the transmitter 102 according to the rules set out in a standard that both the transmitter 102 and the receiver 106 have previously agreed upon. The transmitter 102 converts the data from the data source 100 into symbols for transmission. Typically the symbol set supported is the binary digit set of ‘0’ and ‘1’, wherein the symbols are conventionally referred to as bits. The symbols are transmitted as a datastream through the transmission medium 104, which is depicted here as a satellite based wireless system, though in practice it could be a conventional copper wire, fibre optic, non-satellite based wireless, or any other transmission medium. The transmission medium 104 allows the datastream of symbols to be transmitted to the receiver 106, which accepts the datastream through the receiver interface 108, and a demodulator 110. These components are known in the art and are not necessary in every embodiment of the present invention though they are shown as part of this exemplary embodiment. The synchronizer 112 receives the demodulated datastream, and provides at its output a synchronization signal that can be used by other components of the receiver 106 to determine where to start and stop the decoding of the signal. After the synchronization of the receiver 106 to the transmitter 102 the synchronizer 112 can serve to check that the synchronization is maintained. The receiver 106, after being synchronized, provides decoded data to a destination 114.

The method by which the receiver 106 is synchronized to the transmitter 102 is referred to as word-based synchronization. The datastream is not necessarily an unformatted random stream of symbols, instead it can be a highly ordered data flow. Typically the datastream is divided into frames or words. Each word can be either a data word or a synchronization word. The synchronization words serve to allow the receiver 106 find the start of a data word so that the decoding of the signal can be done without synchronization induced errors. Upon confirming the presence of a synchronization word the synchronizer 112 informs other components of the receiver 106 so that decoding of the message can proceed.

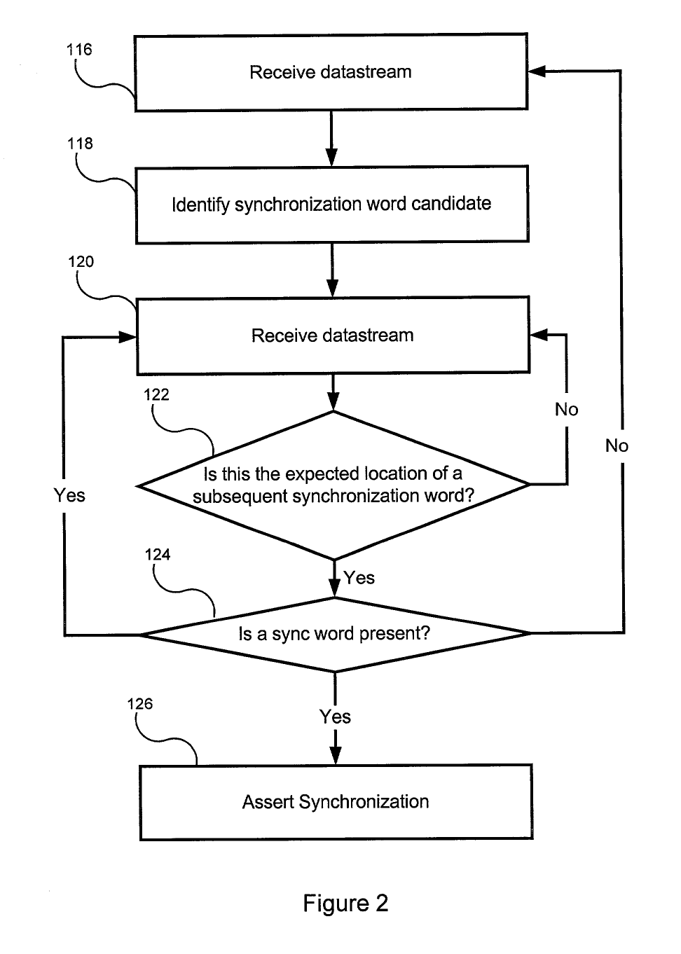

The process of detecting a synchronization word must account for the fact that erroneous synchronization words can occur in the middle of a data word as a result of the random, or pseudo-random, nature of data transmission. The process is illustrated in FIG. 2 and begins by receiving the datastream 116. The received datastream is then analyzed to identify a synchronization word candidate 118. The synchronization word found in this initial search is considered a candidate because at this point it is not possible to know if it is a valid synchronization word, or just a random occurrence. After identifying the synchronization word candidate more data is received 120. The content of this data is ignored by the synchronizer, but the symbols in the stream are counted. This process of ignoring the data is continued until the end of the data word, where it is expected that a subsequent synchronization word will occur 122. After detecting the location of a subsequent expected synchronization word a determination of whether or not a synchronization word is present is made 124. If no synchronization word is found the synchronizer 112 examines the data to find a new synchronization word candidate. If a synchronization word is found at the expected location the synchronizer repeats the process of receiving the datastream 120, and checking the location of the next expected synchronization word 124. The synchronizer 112 checks the stream for a series of consecutive synchronization words in the correct location. Since the datastream can be modeled as a pseudo-random sequence of symbols it is possible to calculate a probability of encountering a given number of false synchronization words consecutively. The number of synchronization words required to reach a desired reliability is calculable with sufficient stochastic information about the datastream. In a presently preferred embodiment the synchronizer 112 checks for seven consecutive synchronization word in their correct locations. As one skilled in the art will appreciate it is possible to vary this number without changing the scope of the present invention. If the predetermined number of synchronization words are found in 124, then the process terminates with the synchronizer 112 asserting that word-based synchronization of the receiver to the transmitter has been achieved 126.

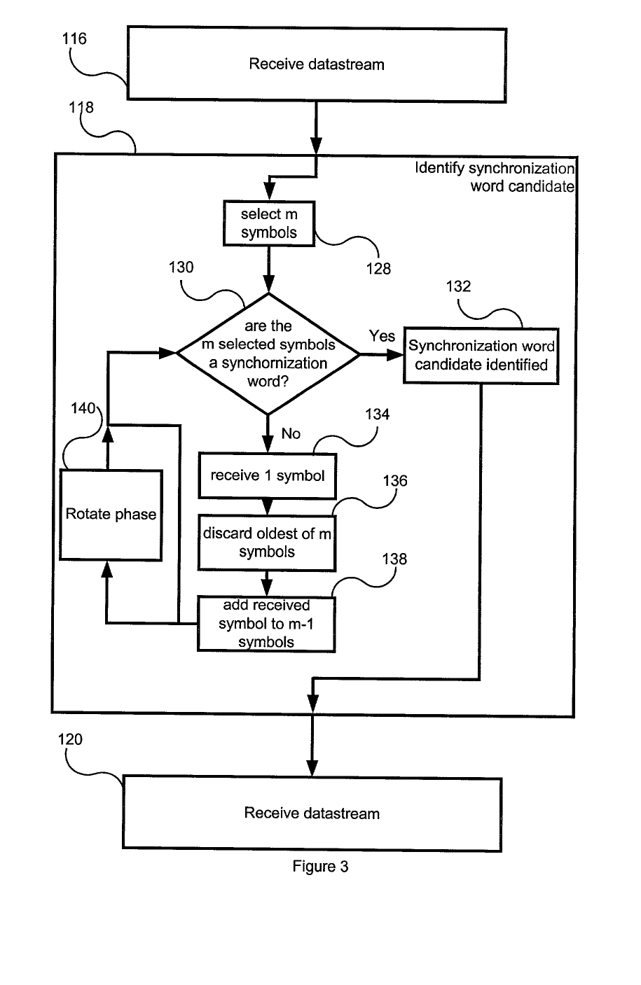

Several of the steps of the previously described process can be elaborated upon to provide more detail as to the operation of various embodiments of the invention. FIG. 3 illustrates how a particular embodiment accomplishes the step of identifying a synchronization word candidate 118. After receiving a set of symbols a given number, m, are chosen 128, where m is the known length of the synchronization word. The m selected symbols are then compared to the known synchronization word 130. If the m selected symbols match the synchronization word then the synchronization word candidate has been identified 132, and the process continues with the continued receiving of the data stream 120. If the m selected symbols do not form the known synchronization word a new symbol is received from the data stream 134. The oldest symbol of the previously selected m symbols is discarded 136, and the newly received symbols is added to the remaining m-1 symbols 138. Whether the new symbol is added to the front or back of the m-1 symbols is determined by whether the synchronizer 112 is operating in a most-significant-bit or least-significant-bit mode. With the new m selected symbols a comparison is made to the known synchronization word 130. This pattern of obtaining new m-length symbol words is continued until a synchronization word candidate has been identified 132. Because the transmitter 102 and receiver 106 have an agreed protocol to follow, the receiver 106 expects that there will be one synchronization word within every block of a predetermined length. It is possible for the synchronization word to be corrupted in transmission, and for the synchronizer 112 to fail to detect it as a result. Once again, given the stochastic nature of the channel it is possible to identify a length of symbols in which there is a very high statistical probability of finding a synchronization word. If no synchronization word has been found in a set of symbols of that length then the synchronizer can rotate the phase of the receiver 140. If the receiver is using quadrature phase shift keying modulation, quadrature amplitude modulation, or other phase rotating communication methods, there is the possibility of multiple different phases that the datastream could be in. Failure to detect a synchronization word in a sufficiently long set of received symbols may indicate that the wrong phase is used. Thus after rotating phase the synchronization word may be easily found. In a presently preferred embodiment all phases of a datastream are analyzed simultaneously. This embodiment offers a faster response to synchronizing the receiver as the different phases are analyzed in parallel, and not in series. After detecting the presence of the synchronization word, the other phases can be ignored by the receiver 106.

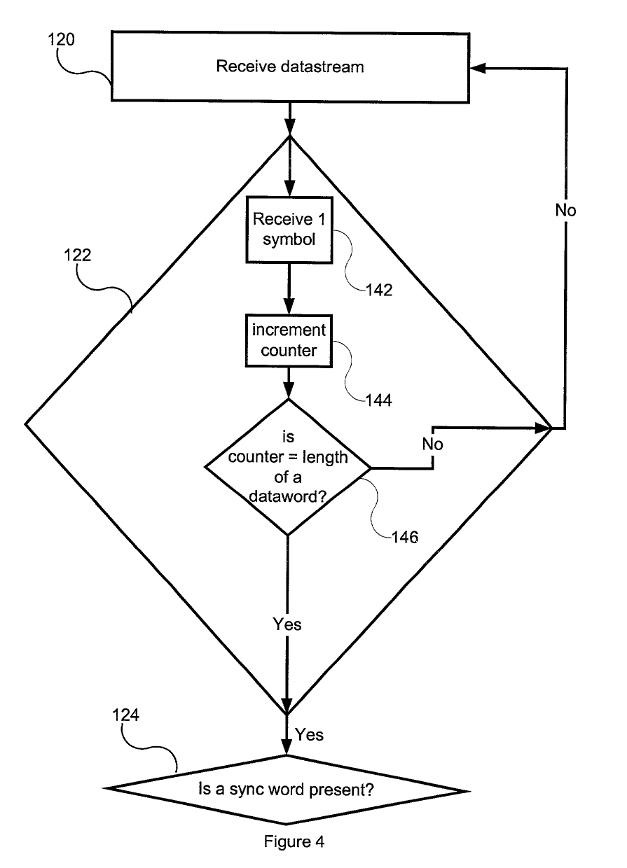

The step of arriving at the next expected location of a synchronization word 122 is illustrated in more detail in FIG. 4. The receiver 106 and the transmitter 102 have previously agreed upon a data transfer protocol that defines the size, location and number of synchronization words, as well as the size and placement of data words. As a result after a synchronization word candidate has been found the synchronizer 112 can predict where the next synchronization word will occur by waiting until the number of symbols in the data word has passed. To perform this, the synchronizer receives a single symbol 142, and increments a counter 144. The counter is then compared to the known length of a data word 146. If the counter is not equal to the length of a data word then the synchronizer accepts the next symbol 120. If the counter is equal to the known length of a synchronization word the process is permitted to continue by analyzing m symbols starting at that location, to determine whether they form a synchronization word 124.

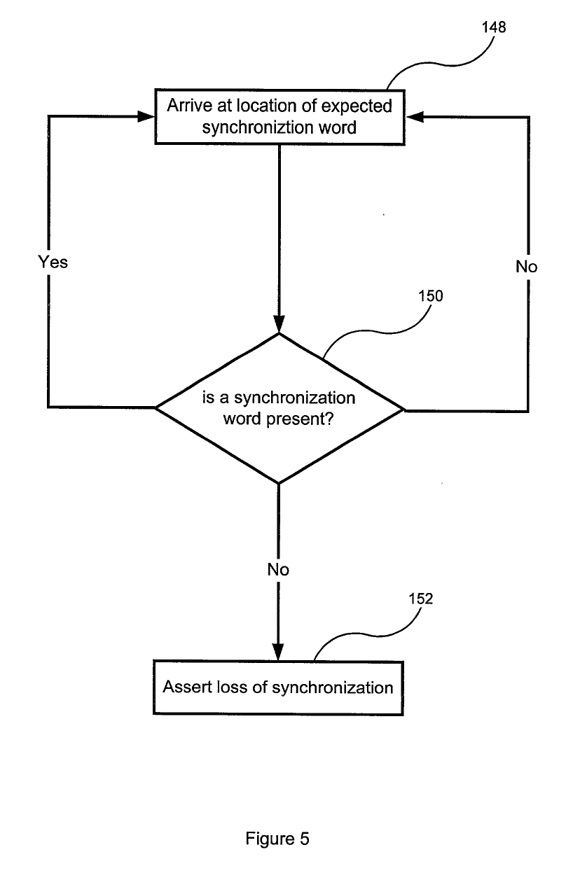

After word based synchronization has been asserted the receiver 106 can decode the data words in the datastream. The synchronizer 112 switches from acquisition mode to tracking mode upon asserting synchronization between the receiver and the transmitter. The purpose of tracking mode is to ensure that the receiver 106 and the transmitter 102 remain synchronized. There are a number of factors that could lead to the receiver 106 and the transmitter 102 failing to maintain synchronization, including noise over the transmission channel 104, and variations in the encoding clock in the receiver 106. The process by which the synchronization is tracked is illustrated for exemplary purposes in FIG. 5. Upon arriving at the expected location of synchronization word 148, the synchronizer 112 checks for the presence of a synchronization word 150. If a synchronization word is present the process is repeated. If no synchronization word is present the synchronizer 112 checks for the next synchronization word. If the synchronizer 112 fails to detect a predetermined number of synchronization words, the synchronizer 112 asserts a loss of synchronization 152. As in the acquisition mode there can be numerous synchronization words that can indicate structure of the datastream. Additionally, as in the acquisition mode, the datastream formatting is determined by the communications protocol, and the method of tracking can include the step of selecting the synchronization word or words that the synchronizer 112 will compare against.

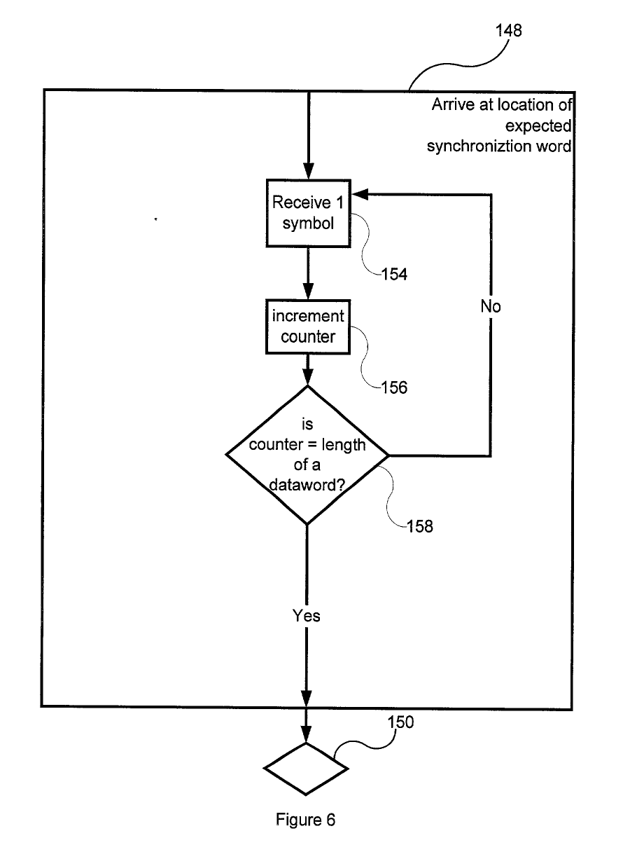

The step of arriving at the expected location of a synchronization word 148 is illustrated in FIG. 6. Finding the next expected location can be performed by starting at the end of a previous synchronization word and receiving a symbol 154 and incrementing a counter 156 for each symbol received. When the counter is less than the length of the data word 158, as defined in the protocol specification, the synchronizer 112 continues to receive symbols. When the counter is equal to the length of a data word 158 the determination is made that the start of the next synchronization word will be at the next symbol received. The process then continues by determining if a synchronization word is present 150 as in the previous example.

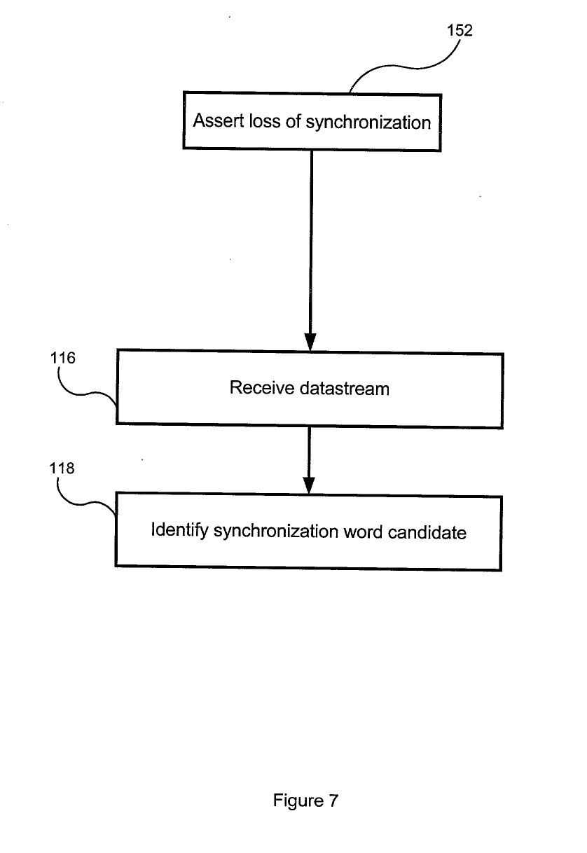

As was mentioned earlier, the tracking mode, as illustrated in FIG. 5, is entered into after the synchronization of the receiver 106 to the transmitter 102 has been asserted. As illustrated in FIG. 7, if loss of synchronization is asserted 152 the acquisition phase is re-entered. After the loss of synchronization is asserted 152, the synchronizer 112 begins to receive the datastream 116, so that a first synchronization word candidate can be found 118.

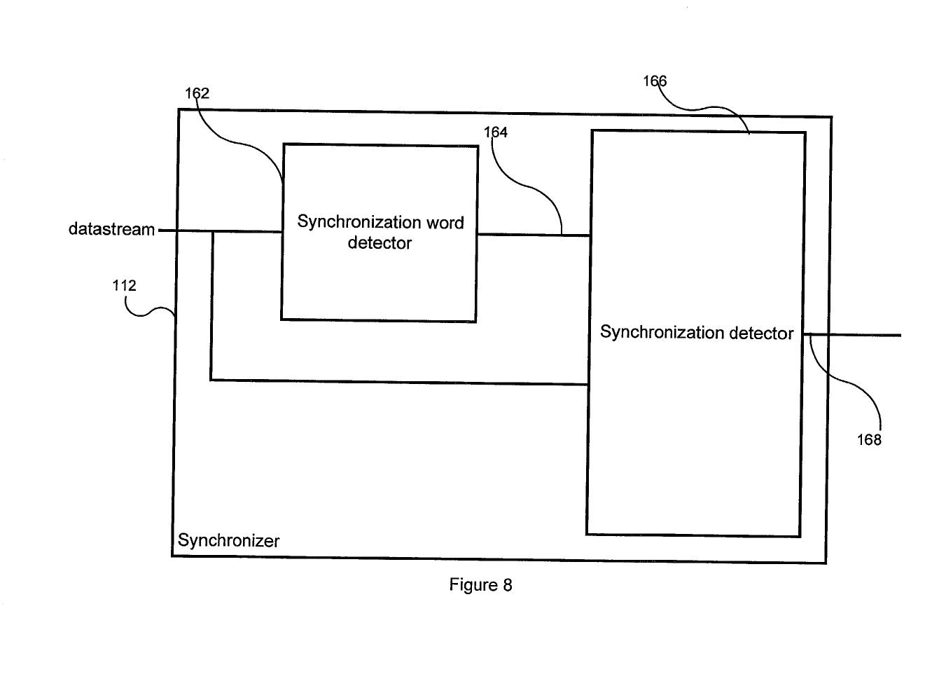

An embodiment of the system of the present invention is illustrated in FIG. 8. The synchronizer 112 is receives a datastream and provides it to the synchronization word detector 162. The synchronization word detector 162, analyzes the datastream and provides an indication, in the form of a synchronization word detect signal 164, when a synchronization word has been found. The synchronization word detect signal 164 is provided to a synchronization detector 166. The synchronization detector 166, also accepts as an input the datastream. The detector 166 determines if the detected synchronization word has occurred in the correct location, and maintains a count of the number of synchronization words received and lost. The synchronization words received and lost are used to determine whether or not synchronization has been acquired or lost by the synchronization detector 166, which provides indication of the respective state through a synchronization lock signal 168.

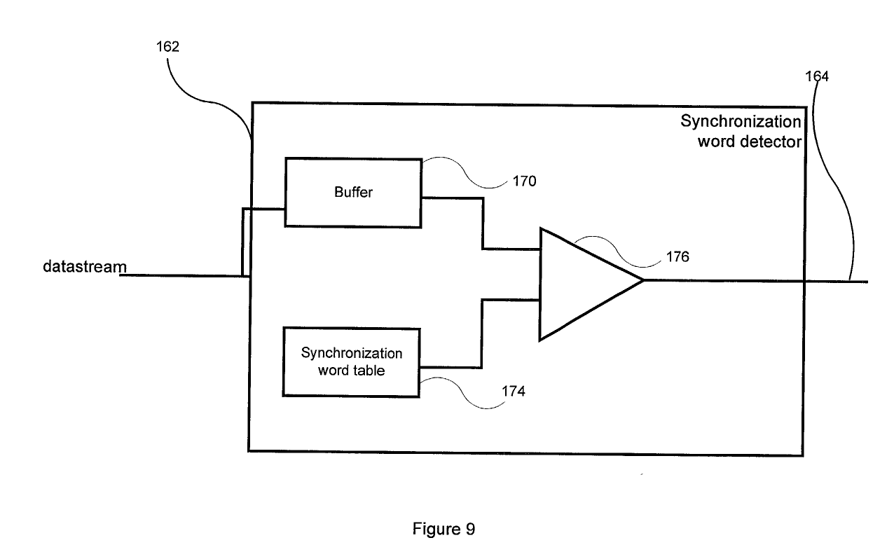

The synchronization word detector 162 is illustrated in FIG. 9. The data stream is provided to a buffer 170, which stores incoming symbols. These symbols are compared to values found in the synchronization word table 174, by a comparator 176. The comparator 176 typically compares the contents of the buffer to one or more entries in the synchronization word table 174, and may do all the comparisons in parallel, in series, or in some combination thereof. The result of the comparison is provided as the output of the synchronization word detector 162, the synchronization word detect signal 164. The entries in the synchronization word table 174, may optionally be programmable, to allow for modification of the protocols supported by the synchronizer 112.

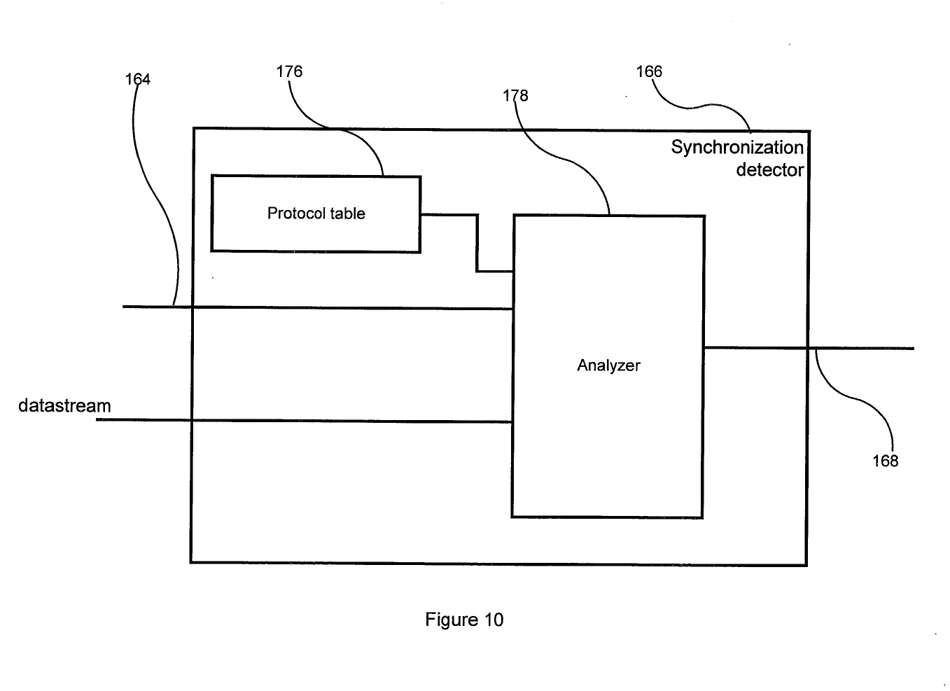

The synchronization detector 166, is illustrated in greater detail in FIG. 10 for exemplary purposes. An analyzer 178, accepts as input the datastream, the synchronization word detect signal 164, and information from a protocol table 176. The information from the protocol table 176, allows the analyzer 178 to detect where in the datastream a synchronization word should be. Additionally the information in the protocol table 176 will specify how many synchronization words must be found before asserting synchronization, how many synchronization words must be missed before asserting loss of synchronization, if the synchronization words in either case must be contiguous, and any other rules or standards that must be followed. The analyzer 178 provides the synchronization lock signal 168 as its output. The synchronization word detector 162, may contain a phase rotator to allow the different phases of the datastream to be analyzed either in serial or in parallel. If the synchronization word detector 162, employs a phase rotator, the synchronization detector 166 can employ a phase selector to select the phase to which the receiver has been synchronized.

An example of the implementation of a specific, non-limiting, embodiment of the present invention will now be illustrated to provide information about the application of this invention. The Sync Detect block as implemented is capable of detecting a repetitive bit pattern from a continuous bit stream. This embodiment assumes that the bit stream contains one of at most two Sync Words at fixed intervals, though the invention has no such limitation. For example:

47h+203 bytes of random data+47h+203 bytes of random data+47h+ . . .

This block attempts to detect patterns of Sync Words in the data stream. The number of Sync Words is programmable between 0 and 2. One of these Sync Words is the Superframe marker, the other is the Frame marker. The length of each Sync Word is programmable, as is the Sync Word itself. In this embodiment the maximum Sync Word length is 64 bits, though the invention has no such limitation. The Sync Word length need not be a multiple of 8 bits. The Sync Word length should be set to 0 to disable that particular Sync Word. The Sync Words is programmed MSB-aligned to allow for easier implementation with MSB-aligned standards, though a LSB-aligned implementation is possible for either MSB or LSB aligned standards.

The Sync Pattern defines a pattern of Superframe and Frame Sync Words, each separated by “frame_size” bits. The Sync Pattern is programmable up to 16 markers in length. The pattern is specified MSB-aligned, using the following encoding scheme:

| Code | Desciption |
|---|---|
| 00 | end-of-pattern |
| 01 | expect Frame Word |
| 10 | expect Superframe |
| | Word |
| 11 | undefined |

The Sync Detect block has 2 states of operation, “acquisition” and “tracking”. In Acquisition mode, a number of counters are used to attempt to detect the pattern of Sync Words in the bit stream. When the Sync Words have been detected “num_match” consecutive times, the Sync Detect module switches to tracking mode. Data is output only when the sync detector is in Tracking mode.

The Sync Pattern is composed of sixteen 2-bit fields. Each field must be programmed with the Sync Word expected in that pattern. The code 2′b10 is used to represent an expected Frame sync, and the code 2′b10 to represent an expected Super Frame sync.

For MPEG, the Sync Words are 47h (Frame) and B8h (Superframe). The Sync Pattern is B8h, 47h, 47h, 47h, 47h, 47h, 47h, 47h, with data frames between the frame markers, and between the superframe and frame marker. This pattern is represented by programming the Sync Pattern Length register with 8, and setting the Sync Pattern to a value of 32′h9555000. The Num Match register should be set to 4, and the Missed sync register should be set to 3. These must be programmed by software at system start-up, since there are no initial values.

The above-described embodiments of the invention are intended to be examples of the present invention. Alterations, modifications and variations may be effected the particular embodiments by those of skill in the art, without departing from the scope of the invention which is defined solely by the claims appended hereto.

We claim:

1. A method of acquiring word-based synchronization, to a transmitter, in a receiver receiving a datastream of data words separated by synchronization words, comprising:
a) identifying a first synchronization word candidate;
b) at an expected location of a subsequent synchronization word, determining that no synchronization word is present;
c) analyzing the data stream one symbol at a time to identify a next synchronization word candidate; and
d) if at a subsequent expected location of a synchronization word a synchronization word is present, asserting synchronization of the receiver to the transmitter.

2. A method, as in claim 1, further including the step of selecting the synchronization word used to separate the data words.

3. A method, as in claim 1, wherein there are a plurality of distinct synchronization words.

4. A method, as in claim 3, wherein the plurality of distinct synchronization words indicate different data structures in the datastream.

5. A method, as in claim 3, wherein the step of determining that no synchronization word is present determines that none of the plurality of synchronization words are present.

6. A method, as in claim 5, wherein the step of determining that none of the plurality of synchronization words are present includes the simultaneous comparison of datastream elements to all of the plurality of synchronization words.

7. A method, as in claim 1, including the step of rotating the phase of the receiver after determining that a synchronization word is not present.

8. A method, as in claim 7, wherein the step of rotating the phase of the receiver precedes step (a).

9. A method, as in claim 8, wherein the step of rotating the phase of the receiver is performed if no synchronization word is found within a predetermined number of samples.

10. A method, as in claim 1, including the step of repeating, for a predetermined number of times, the step of determining that a synchronization word is present at a subsequent expected location, prior to asserting synchronization.

11. A method, as in claim 1, wherein the step of identifying the first synchronization word includes analyzing the data stream one symbol at a time to identify a synchronization word candidate.

12. A method, as in claim 11, wherein the step of analyzing the data stream one symbol at a time to identify a synchronization word candidate is followed by rotating the phase of the receiver if, after a predetermined number of symbols, no synchronization word candidate is found.

13. A method, as in claim 1, wherein a plurality of phases of the datastream are analyzed simultaneously and independently.

14. A method, as in claim 13, wherein a step of discarding the non-synchronized phases follows step (d).

15. A method, as in claim 1, wherein the expected location of a subsequent synchronization word is a multiple of the length of a data word from the end of the synchronization word candidate.

16. A method of tracking loss of word-based synchronization, to a transmitter, in a receiver receiving a datastream of data words separated by synchronization words, comprising:
a) failing to detect a synchronization word at an expected location of a synchronization word;
b) asserting the loss of synchronization of the receiver to the transmitter if the step of failing to detect a synchronization word is repeated a predetermined number of times.

17. A method, as in claim 16, further including the step of selecting the synchronization word used to separate the data words.

18. A method, as in claim 16, wherein there are a plurality of distinct synchronization words.

19. A method, as in claim 18, wherein the plurality of distinct synchronization words indicate different data structures in the datastream.

20. A method, as in claim 18, wherein the step of determining that no synchronization word is present determines that none of the plurality of synchronization words are present.

21. A method, as in claim 20, wherein the step of determining that none of the plurality of synchronization words are present includes the simultaneous comparison of datastream elements to all of the plurality of synchronization words.

22. A method, as in claim 16, wherein the expected location of a synchronization word is a multiple of the length of a data word from the end of a previous synchronization word.

23. A method, as in claim 16, wherein asserting the loss of synchronization of the receiver requires failing to detect a synchronization word in consecutive attempts.

24. A method, as in claim 16, wherein asserting the loss of synchronization of the receiver requires failing to detect a synchronization word a predetermined number of non-consecutive times in a predetermined number of attempts.

25. A system for acquiring and tracking word-based synchronization, to a transmitter, of a receiver receiving a datastream of data words separated by synchronization words, comprising:
a synchronization word detector, for receiving the datastream and providing a synchronization word detect signal when a synchronization word in the datastream is detected; and
a synchronization detector, operatively connected to the synchronization word detector, for receiving the synchronization word detect signal and for providing a synchronization lock signal when a predetermined number of synchronization words are detected.

26. A system, as in claim 25, wherein the synchronization word detector includes a synchronization word table.

27. A system, as in claim 26, wherein the synchronization word table is programmable.

28. A system, as in claim 26, wherein the synchronization word table contains at least one synchronization word.

29. A system, as in claim 26, wherein the synchronization word table contains a plurality of synchronization words.

30. A system, as in claim 29, wherein the comparator provides a synchronization word detect signal when any synchronization word in the synchronization word table is detected in the datastream.

31. A system, as in claim 25, wherein the synchronization word detector has a phase rotator.

32. A system, as in claim 31, wherein the synchronization word detector detects the presence of a synchronization word in any phase of the datastream.

33. A system, as in claim 25, wherein the synchronization detector includes a protocol table.

34. A system, as in claim 33, wherein the protocol table is programmable

35. A system, as in claim 33, wherein the protocol table contains information about the structure of more than one datastream protocol.

36. A system, as in claim 25, wherein the synchronization detector includes a phase selector.
